(19) United States
(12) Patent Application Publication
(10) Pub. No.: US 2009/0193175 A1
(43) Pub. Date: Jul. 30, 2009

(54) IDENTIFICATION OF AN ONBOARD MEMORY BUFFER DEVICE FROM A SYSTEM ADDRESS

(75) Inventor: Oswin HOUSTY, Austin, TX (US)

Correspondence Address: INGRASSIA FISHER & LORENZ, P.C. (AMD), 7010 E. COCHISE ROAD, SCOTTSDALE, AZ, 85253, US

(73) Assignee: ADVANCED MICRO DEVICES, INC., Austin, TX (US)

(21) Appl. No.: 11/953,415

(22) Filed: Jan. 28, 2008

(51) Int. Cl. G06F 12/00

(52) U.S. Cl. 711/101; 711/E12.001

(57) ABSTRACT

Disclosed herein are techniques and methods for identifying a target onboard memory buffer device from a system address of a computer system. The techniques and methods can be employed in a computer system having a system controller, main memory having memory devices, and onboard memory buffer devices between the system controller and the main memory. One embodiment of the method obtains a system address that conveys a physical address within the computer system, decodes the system address to determine a target channel controller in the computer system, and identifies at least one memory buffer device associated with the target channel controller.

### TECHNICAL FIELD

Embodiments of the subject matter described herein relate generally to data processing systems. More particularly, embodiments of the subject matter relate to a diagnostic memory checking routine for use with a data processing system.

### BACKGROUND

A computer system is generally defined in terms of three basic system elements: a central processing unit (CPU), memory, and input/output (I/O) peripheral devices. A typical computer system works with a computer program known as an operating system (OS). The OS is a program that manages all other programs in a computer, the user interface, the interface with peripheral devices, memory allocation, and so forth. Each OS is written for a variety of system configurations and thus it can remain ignorant of the actual system configuration.

On the other hand, the basic input/output system (BIOS) is a computer program that uses the actual system configuration to manage data flow between the OS and attached memory and I/O peripherals. The BIOS can translate OS requests into concrete actions that the CPU can take in response. The BIOS is usually stored on a nonvolatile memory device such as a read-only memory (ROM) and may be programmed for the particular system configuration.

The BIOS also manages operation of the computer system after startup and before control is passed to the OS. The BIOS typically performs a memory check after power-on to determine whether the memory physically present in the system is operational and can be used by the OS. The BIOS first determines the amount of memory present in the system. It may use a so-called system management (SM) bus to interrogate the memory devices present in the system and thus to determine the nominal size of the memory. Then the BIOS performs a memory test to detect the presence of bad memory elements and to take corrective action if it finds any. Finally it passes control to the OS but thereafter is periodically called by the OS to perform system specific I/O functions.

Recently multiprocessor computer architectures have been introduced for such applications as servers, workstations, personal computers, and the like. In one such multiprocessor architecture the physical memory is distributed among multiple processor nodes. Each node may include a memory controller that is responsible for one or more dynamic random access memory (DRAM) devices of the system. One example of such a computer architecture is disclosed in U.S. Pat. No. 7,251,744, titled Memory Check Architecture and Method for a Multiprocessor Computer System.

### BRIEF SUMMARY

The techniques and methods described herein can be utilized in conjunction with a memory test in a computer system having a processor core, a system controller implemented in the processor core, memory devices (such as DRAM devices), and onboard memory buffer devices between the system controller and the memory devices. When a bad memory buffer device is detected by the memory test, a system address is generated. That system address is then processed to identify the bad memory buffer device.

The above and other aspects may be carried out by an embodiment of a method of identifying target memory buffer devices for a computer system having a processor core, a system controller implemented in the processor core, a plurality of memory devices controlled by the system controller, and a plurality of memory buffer devices coupled between the system controller and the memory devices. The method involves: obtaining a system address that conveys a physical address within the computer system; decoding the system address to determine a target channel controller in the computer system; and identifying at least one memory buffer device associated with the target channel controller.

The above and other aspects may be carried out by an embodiment of a method of identifying a target memory buffer device for a computer system. The method involves: obtaining a system address that conveys a physical address within the computer system; determining, from the system address, a target node in a processing core of the computer system; transforming the system address into a node address; determining, from the node address, a target memory controller in the computer system, the target memory controller being uniquely associated with the target node; transforming the node address into a memory controller address; and determining, from the memory controller address, a target channel controller in the computer system. The target memory buffer device is uniquely associated with the target channel controller.

The above and other aspects may be carried out by an embodiment of a method of identifying a target memory buffer device in a computer system. The method involves: providing a system architecture comprising one or more processor nodes, each of the processor nodes having one or more memory controllers associated therewith, each of the memory controllers having one or more channel controllers associated therewith, and each of the channel controllers having one or more memory buffer devices associated therewith; performing a memory test on the system architecture; generating a system address when the memory test determines that the target memory buffer device has failed; and processing the system address to determine a target channel controller in the computer system. The target memory buffer device is uniquely associated with the target channel controller within a domain of the system architecture.

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

### BRIEF DESCRIPTION OF THE DRAWINGS

A more complete understanding of the subject matter may be derived by referring to the detailed description and claims when considered in conjunction with the following figures, wherein like reference numbers refer to similar elements throughout the figures.

FIG. 1 is a schematic representation of an embodiment of a computer system;

FIG. 2 is a diagram of a hierarchical arrangement of elements in an embodiment of a computer system;

FIG. 3 is a schematic representation of an exemplary embodiment of a computer system;

FIG. 4 is a diagram of a mapping architecture for nodes, memory controllers, and channel controllers in an exemplary embodiment of a computer system;

FIG. 5 is a flow chart of an embodiment of a memory buffer device identification process; and

FIG. 6 is a flow chart of an embodiment of a system address decoding process.

### DETAILED DESCRIPTION

The following detailed description is merely illustrative in nature and is not intended to limit the embodiments of the subject matter or the application and uses of such embodiments. As used herein, the word “exemplary” means “serving as an example, instance, or illustration.” Any implementation described herein as exemplary is not necessarily to be construed as preferred or advantageous over other implementations. Furthermore, there is no intention to be bound by any expressed or implied theory presented in the preceding technical field, background, brief summary or the following detailed description.

Techniques and technologies may be described herein in terms of functional and/or logical block components, and with reference to symbolic representations of operations, processing tasks, and functions that may be performed by various computing components or devices. Such operations, tasks, and functions are sometimes referred to as being computer-executed, computerized, software-implemented, or computer-implemented. In practice, one or more processor devices can carry out the described operations, tasks, and functions by manipulating electrical signals representing data bits at memory locations in the system memory, as well as other processing of signals. The memory locations where data bits are maintained are physical locations that have particular electrical, magnetic, optical, or organic properties corresponding to the data bits. It should be appreciated that the various block components shown in the figures may be realized by any number of hardware, software, and/or firmware components configured to perform the specified functions. For example, an embodiment of a system or a component may employ various integrated circuit components, e.g., memory elements, digital signal processing elements, logic elements, look-up tables, or the like, which may carry out a variety of functions under the control of one or more microprocessors or other control devices.

When implemented in software or firmware, various elements of the systems described herein are essentially the code segments or instructions that perform the various tasks. The program or code segments can be stored in a processor-readable medium or transmitted by a computer data signal embodied in a carrier wave over a transmission medium or communication path. The “processor-readable medium” or “machine-readable medium” may include any medium that can store or transfer information. Examples of the processor-readable medium include an electronic circuit, a semiconductor memory device, a ROM, a flash memory, an erasable ROM (EROM), a floppy diskette, a CD-ROM, an optical disk, a hard disk, a fiber optic medium, a radio frequency (RF) link, or the like. The computer data signal may include any signal that can propagate over a transmission medium such as electronic network channels, optical fibers, air, electromagnetic paths, or RF links. The code segments may be downloaded via computer networks such as the Internet, an intranet, a LAN, or the like.

The following description may refer to elements or nodes or features being “connected” or “coupled” together. As used herein, unless expressly stated otherwise, “connected” means that one element/node/feature is directly joined to (or directly communicates with) another element/node/feature, and not necessarily mechanically. Likewise, unless expressly stated otherwise, “coupled” means that one element/node/feature is directly or indirectly joined to (or directly or indirectly communicates with) another element/node/feature, and not necessarily mechanically.

For the sake of brevity, conventional techniques related to computer processors, system controllers, memory devices, and other functional aspects of the systems (and the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in an embodiment of the subject matter.

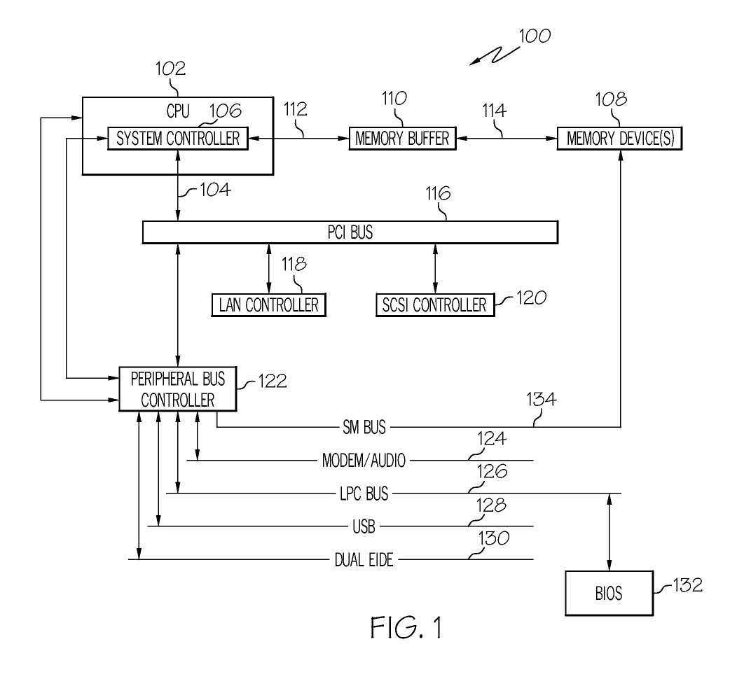

FIG. 1 is a schematic representation of an embodiment of a computer system 100, which may be configured for use as a general purpose personal computer, a server computer, or the like. Certain aspects of computer system 100 are similar to that disclosed in U.S. Pat. No. 7,251,744 (the relevant content of which is incorporated by reference herein). Computer system 100 includes a high-performance central processing unit (CPU) 102 that executes computer readable instructions. CPU 102 may also be referred to herein as a processor core for computer system 100. CPU 102 generally interfaces to external devices over a system bus 104. In this embodiment, computer system 100 utilizes a system controller 106 (conventionally referred to as a “northbridge”) that is implemented in CPU 102. As depicted in FIG. 1, system controller 106 may be coupled to system bus 104. System controller 106 offloads CPU 102 of the task of communicating with high performance system resources which may have different bus structures. For example, system controller 106 is suitably configured to communicate with and control the main memory of computer system 100. This main memory is realized using one or more memory devices 108, such as synchronous dynamic random access memory (SDRAM) or double data rate (DDR) SDRAM.

Notably, system controller 106 communicates with memory devices 108 via a memory buffer 110, which is coupled between system controller 106 and memory devices 108 in this embodiment. As described in more detail below, memory buffer 110 may be realized using any number of onboard memory buffer devices. System controller 106 may be coupled to memory buffer 110 using a dedicated memory bus 112, and in turn memory buffer 110 may be coupled to memory devices 108 using a dedicated memory bus 114.

System controller 106 is also connected to a peripheral component interconnect (PCI) bus 116 to which several other devices, including a local area network (LAN) controller 118 and a small computer system interface (SCSI) controller 120, are connected. Also connected to PCI bus 116 is a peripheral bus controller 122, (conventionally referred to as a “southbridge”) for coupling to certain devices. Peripheral bus controller 122 has various dedicated buses including a modem/audio bus 124, a low pin count (LPC) bus 126, a universal serial bus (USB) 128, and a dual enhanced integrated drive electronics (EIDE) bus 130. One of the devices coupled to LPC bus 126 is a basic input/output system (BIOS) chip 132. Moreover, peripheral bus controller 122 has a bidirectional connection to CPU 102 by which CPU 102 programs it for operation.

In addition, peripheral bus controller 122 has a bus known as a system management (SM) bus 134 by which it is connected to memory devices 108. SM bus 134 is the mechanism by which CPU 102, under the control of the BIOS program stored in BIOS chip 132, is able to perform memory tests on memory devices 108 at startup. This conventional memory test may be performed as follows. After CPU 102 comes up out of reset, it fetches a reset vector pointing to a location in BIOS chip 132 containing the startup program sequence. One of the items performed in the startup program sequence is to determine the configuration of memory devices 108. The BIOS program directs peripheral bus controller 122 to poll memory devices 108 over SM bus 134 to determine how much memory is installed. After determining the memory configuration, the BIOS program performs a memory check through system controller 106. For example, the BIOS program may cause CPU 102 to write a predefined test pattern to all memory locations, and subsequently read the memory locations to determine whether the test pattern was correctly stored. Later, an opposite test pattern may be applied to all memory locations and read back to determine whether each memory cell may assume either logic state. Any bad memory element is noted and used to configure system controller 106, and in this way, bad memory may be mapped out of the system. A similar procedure can be performed by the BIOS program to perform memory tests on memory buffer 1 10.

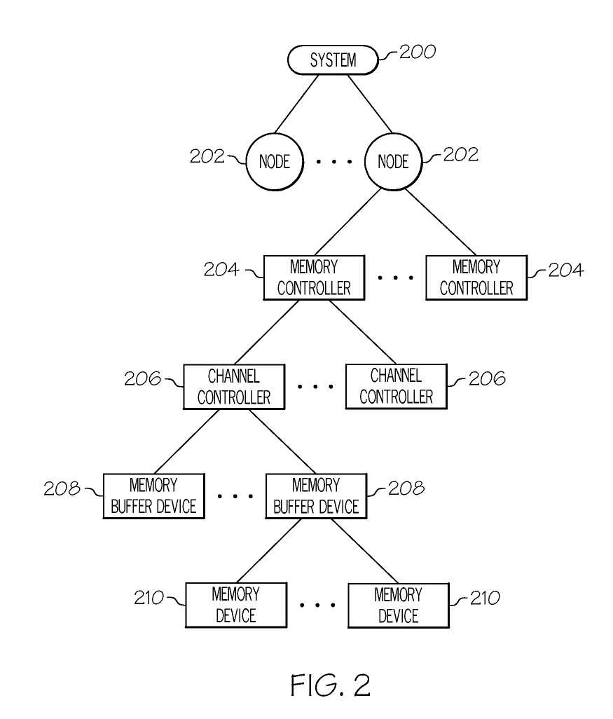

FIG. 1 depicts computer system 100 in a simplified and generalized form. In practice, CPU 102 may include a plurality of processor nodes arranged in an array or fabric in which each node is connected to one or more adjacent nodes. Each node has the capability to connect to local memory that will be directly accessible to it and indirectly accessible to all other nodes. Moreover, in certain embodiments each node has its own system controller. More specifically, each system controller can include or be realized as one or more memory controllers and one or more channel controllers, where these controllers interact with memory buffer 110 and memory devices 108. In this regard, FIG. 2 is a diagram of a hierarchical arrangement of elements in an embodiment of a computer system 200. As schematically depicted in FIG. 2, computer system 200 (and the processor core in particular) includes any number of nodes 202. Although only depicted for one of the nodes 202, each node 202 includes any number memory controllers 204 associated therewith. In this embodiment, each memory controller 204 in computer system 200 is uniquely associated (within the domain of computer system 200) with only one node 202. Although only depicted for one of the memory controllers 204, each memory controller 204 includes any number of channel controllers 206 associated therewith. In this embodiment, each channel controller 206 in computer system 200 is uniquely associated (within the domain of computer system 200) with only one memory controller 204. Although only depicted for one of the channel controllers 206, each channel controller 206 includes any number of memory buffer devices 208 associated therewith. In this embodiment, each memory buffer device 208 in computer system 200 is uniquely associated (within the domain of computer system 200) with only one channel controller 206. Although only depicted for one of the memory buffer devices 208, each memory buffer device 208 includes any number of memory devices 210 associated therewith. In this embodiment, each memory device 210 in computer system 200 is uniquely associated with only one memory buffer device 208.

In practice, a memory controller 204 can represent hardware, software, and/or firmware that is suitably configured to facilitate data transfer between the CPU and both its local memory and remote memory distributed throughout the rest of the system. Memory controller 204 offloads the task of initiating and terminating memory accesses from the CPU. It may include internal queues to allow efficient use of the external bus to the local memory. It may also include memory maps to determine whether an address of a memory access is intended for local memory or for remote memory, in which case it initiates a request packet to another node.

For this embodiment, a channel controller 206 represents hardware, software, and/or firmware that is suitably configured to function as the interface between the memory buffer and the memory controller. A channel controller 206 can control timings, initiate transactions between the memory controller and the memory buffer, and terminate transactions between the memory controller and the memory buffer.

Each memory buffer device 208 is realized as hardware, software, and/or firmware that functions as a buffer between its respective channel controller 206 and its respective memory device(s) 210. A memory buffer device 208 improves the overall performance of computer system 200 by functioning as an interface between relatively high speed data communication links (utilized between memory controllers 204 and channel controllers 206, and between channel controllers 206 and memory buffer devices 208) and relatively low speed data communication links (utilized between memory buffer devices 208 and memory devices 210). Notably, even though memory buffer devices 208 can be implemented as onboard devices (i.e., located on the motherboard of computer system 200), they are not implemented within the CPU itself.

For certain embodiments, a memory device 210 can be realized as a dual inline memory module (DIMM). In this regard, a DIMM is a bank of dynamic random access memory (DRAM). Each memory device 210 interfaces to its respective memory buffer device 208 using a suitable bus interface. For example, the DRAM in memory devices can be compliant with the JEDEC Double Data Rate (DDR) SDRAM Specification, Standard JESD79, Release 2, May 2002.

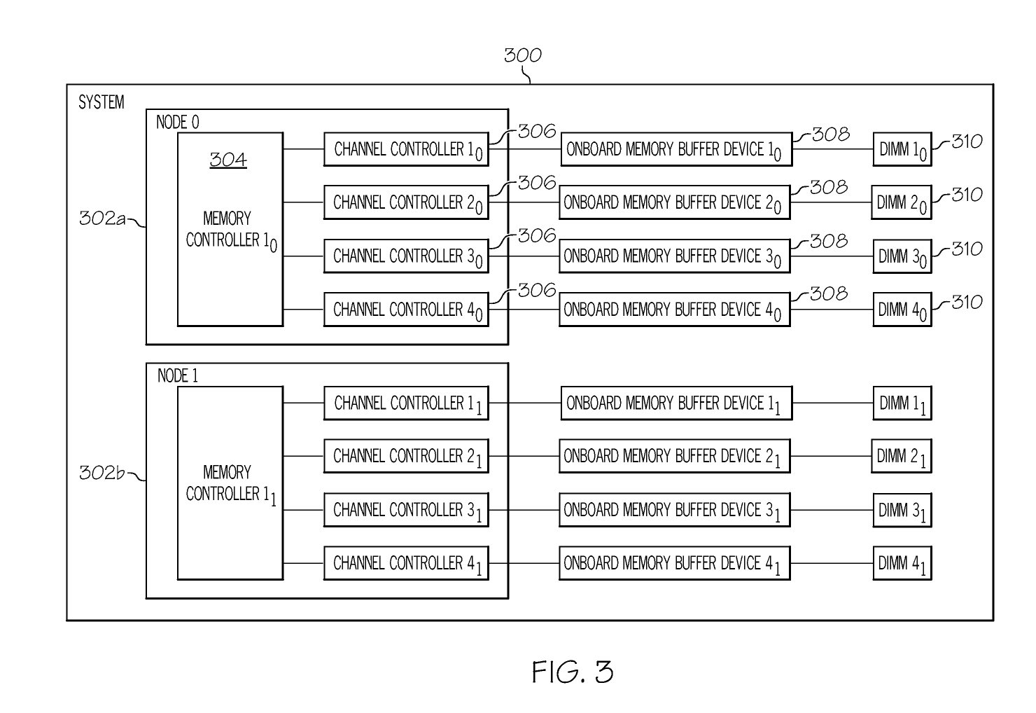

FIG. 3 is a schematic representation of an exemplary embodiment of a computer system 300 having two processor nodes 302. Computer system 300 is provided as one practical embodiment of a system architecture, and the arrangement depicted in FIG. 3 is not intended to limit or otherwise restrict the application or scope of the embodiments described here. For this particular embodiment, node 302a (identified as Node Zero) includes one memory controller 304, which is associated with four channel controllers 306. Also for this embodiment, each channel controller 306 is associated with only one onboard memory buffer device 308, and each memory buffer device is associated with only one DIMM 310. The subscript numeral zero in FIG. 3 indicates that those designated elements correspond to node 302a. A similar arrangement of elements is utilized for node 302b, and the subscript numeral one in FIG. 3 indicates that those designated elements correspond to node 302b.

Although the physical memory in computer systems 100/200/300 is distributed among the nodes, all the memory can be configured to be visible to every node. Thus the array or nodes is configured by programming respective nodes with configuration information. This configuration information can be used to form a system address map (which is a table of all memory and memory-mapped I/O devices in the system), a node address map, a memory controller address map, and a channel controller address map. These maps are arranged in a hierarchical arrangement, and address translations, mappings, and conversions may be performed such that the computer system can transition between different address domains (corresponding to system addresses, node addresses, memory controller addresses, and channel controller addresses).

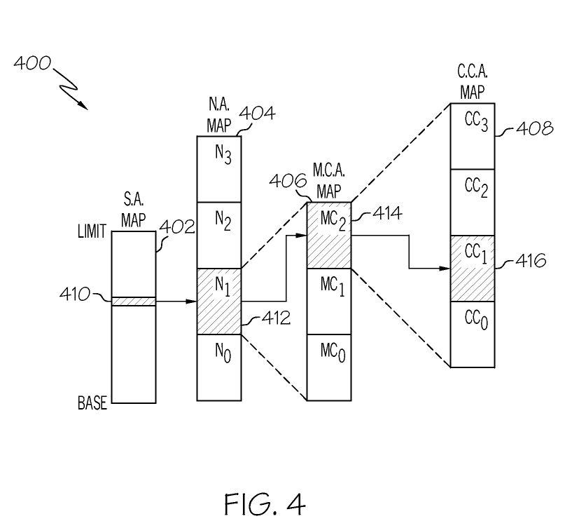

FIG. 4 is a diagram of a mapping architecture 400 for nodes, memory controllers, and channel controllers in an exemplary embodiment of a computer system. Mapping architecture 400 represents one possible arrangement for a computer system; in practice, the implementation of a mapping architecture will be tailored according to the particular configuration of the computer system. As described in more detail below, a mapping architecture such as this can be used to identify a bad (failed) memory buffer device in the computer system by performing a “table walk” of the mapping architecture to determine the particular node, memory controller, and channel controller corresponding to the bad memory buffer device.

More specifically, mapping architecture 400 includes a system address map 402; a node address map 404; a memory controller address map 406; and a channel controller address map 408. System address map 402 is characterized by base and limit addresses corresponding to all the physical addresses of memory and memory-mapped I/O devices present in the system. In practice, a system address is a numerical identifier, such as a 40-bit binary string, that conveys a physical address/location within the particular computer system. An input physical address 410 (depicted as a shaded entry) will be present in the computer system if it is contained in system address map 402. In the case of a contiguous memory map as in FIG. 4, the physical address 410 will be present in the system if it falls between the base address and the limit address of system address map 402. Non-contiguous system address maps are possible as well.

Node address map 404 includes a listing of available relative node addresses (RNAs) for all the nodes. A particular physical address will signify a node number and an RNA within that node. In the case of a contiguous memory map for node 412 (Node One), for example, if the RNA falls between the base address and the limit address for node 412, then it is present on node 412. For this particular embodiment, the base address of Node Zero is the lowest address in node address map 404, and the limit address of Node Three is the highest address in node address map 404. Moreover, the limit address of Node Zero is less than the base address of Node One, the limit address of Node One is less than the base address of Node Two, and the limit address of Node Two is less than the base address of Node Three.

Memory controller address map 406 includes a listing of memory controller addresses for the memory controllers in the system. For this embodiment, a given node address can be mapped, translated, transformed, decoded, converted, or otherwise processed into a corresponding memory controller address that has context within the domain of memory controller addresses. For this example, one entry in node address map 404 will be mapped to only one memory controller; it will fall within the range of the addresses decoded by that particular memory controller. A particular node address may signify a memory controller number and a relative memory controller address for that memory controller. In the case of a contiguous memory map for memory controller 414 (MC Two), for example, if the memory controller address falls between the base address and the limit address for memory controller 414, then it is present on memory controller 414. For this particular embodiment, the base address of MC Zero is the lowest address in memory controller address map 406, and the limit address of MC Two is the highest address in memory controller address map 406. Moreover, the limit address of MC Zero is less than the base address of MC One, and the limit address of MC One is less than the base address of MC Two.

Channel controller address map 408 includes a listing of channel controller addresses for the channel controllers in the system. For this embodiment, a given memory controller address can be mapped, translated, transformed, decoded, converted, or otherwise processed into a corresponding channel controller address that has context within the domain of channel controller addresses. For this example, one entry in memory controller address map 406 will be mapped to only one channel controller; it will fall within the range of the addresses decoded by that particular channel controller. A particular memory controller address may signify a channel controller number and a relative channel controller address for that channel controller. In the case of a contiguous memory map for channel controller 416 (CC One), for example, if the channel controller address falls between the base address and the limit address for channel controller 416, then it is present on channel controller 416. For this particular embodiment, the base address of CC Zero is the lowest address in channel controller address map 408, and the limit address of CC Three is the highest address in channel controller address map 408. Moreover, the limit address of CC Zero is less than the base address of CC One, the limit address of CC One is less than the base address of CC Two, and the limit address of CC Two is less than the base address of CC Three.

As explained with reference to FIG. 2 and FIG. 3, a given channel controller is associated with at least one memory buffer device. As described in more detail below, mapping architecture 400 can be used to determine/identify a particular channel controller that is associated with a bad memory buffer device. Once that channel controller has been identified, any memory buffer devices under its control are assumed to be bad and appropriate corrective action can be taken. For example, those memory buffer devices can be removed and replaced.

It may be desirable to perform memory tests in a computer system such as computer systems 100/200/300. For example, it may be useful to perform a memory test on the computer system to diagnose the health and/or operation of the onboard memory buffer devices. For the embodiments described herein, such memory tests are performed by the host computer system itself (in particular, the BIOS program may be suitably configured to perform the memory tests). If a memory buffer device is not functioning according to its specifications, then the memory test will generate a system address corresponding to the bad memory buffer device. Thereafter, the system address is processed to identify and locate the bad memory buffer device. In certain embodiments, the processing of the system address is also performed by the host computer system, for example, by the BIOS program. In such embodiments, the BIOS program obtains the specified system address and decodes the system address to identify the bad memory buffer device. In other embodiments, the host computer system sends the system address to another computing device that is remote from the host computer system, for example, a server computer coupled to the host computer system via a network. In such embodiments, the remote computing device receives the system address from the host computer system and performs decoding of the system address.

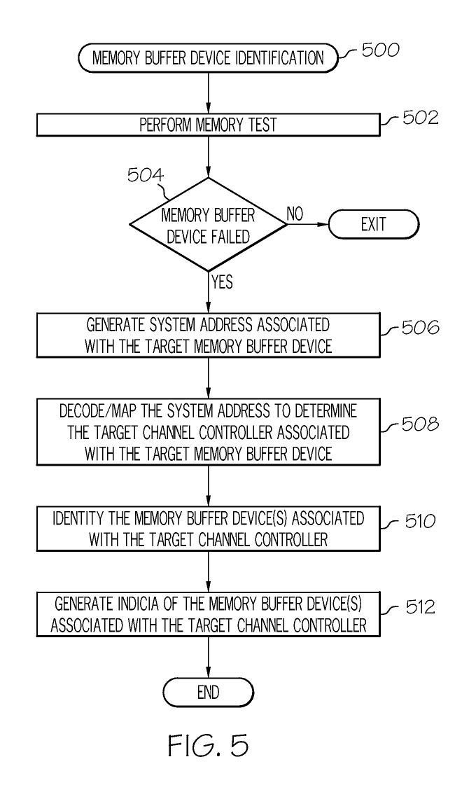

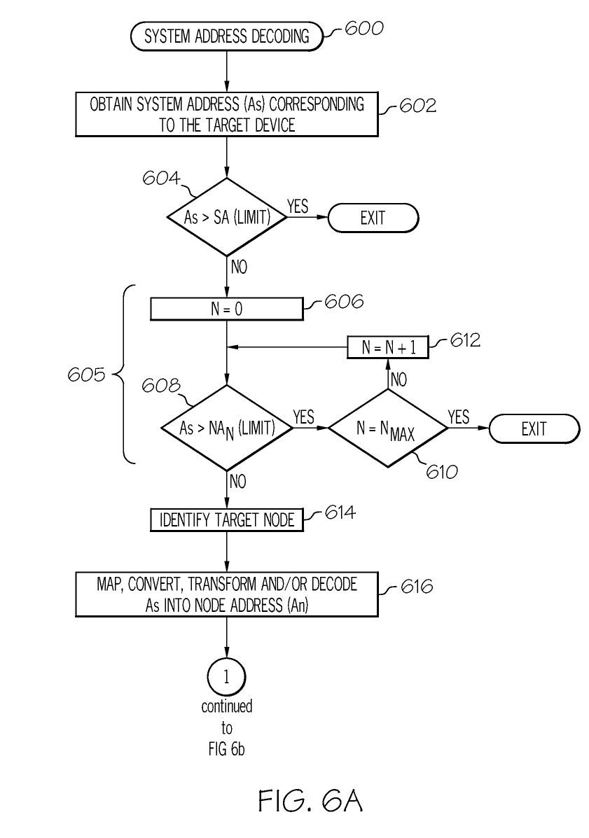

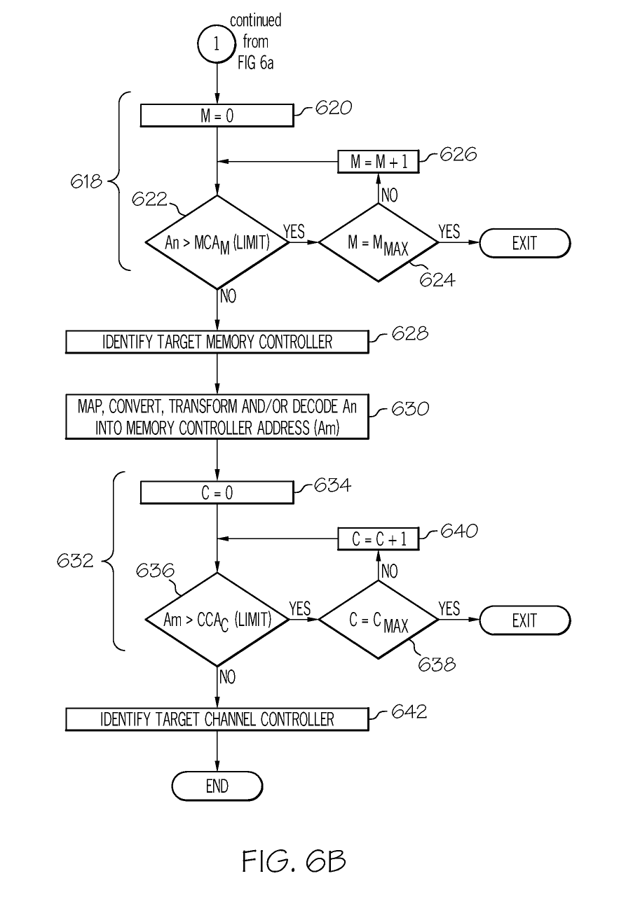

The processing of a system address will be described in more detail with reference to FIG. 5 and FIG. 6. FIG. 5 is a flow chart of an embodiment of a memory buffer device identification process 500, and FIG. 6 is a flow chart of an embodiment of a system address decoding process 600. The various tasks performed in connection with these processes may be performed by software, hardware, firmware, or any combination thereof. For illustrative purposes, the following description of processes 500/600 may refer to elements mentioned above in connection with FIGS. 1-4. It should be appreciated that a given process 500/600 may include any number of additional or alternative tasks, the tasks shown in FIG. 5 and FIG. 6 need not be performed in the illustrated order, and that process 500 and/or process 600 may be incorporated into a more comprehensive procedure or process having additional functionality not described in detail herein.

Referring to FIG. 5, memory buffer device identification process 500 begins by performing an appropriate memory test on the computer system (task 502). Again, this memory test is designed to detect whether a memory buffer device in the computer system has failed. If the memory test determines that no memory buffer device has failed (query task 504), then process 500 may exit or be reentered at task 502. If, however, the memory test finds a bad memory buffer device, then process 500 will generate a system address that is associated with a target memory buffer device (task 506). As mentioned previously, this system address will convey (usually in an indirect or encoded manner) a physical address within the computer system.

Next, process 500 will process the system address (task 508) in an appropriate manner to determine a target channel controller in the computer system, where the target memory buffer device is uniquely associated with the target channel controller (within the domain of the particular system architecture). In practice, the processing of the system address may include decoding, mapping, conversion, translation, and/or transformation of the system address into different address formats, as described in more detail below. Thus, with knowledge of the target channel controller, process 500 can identify at least one memory buffer device (including the target memory buffer device) that is associated with that target channel controller (task 510). If the system architecture includes only one memory buffer device connected to the target channel controller, then task 510 will identify that particular memory buffer device. On the other hand, if the system architecture includes more than one memory buffer device connected to the target channel controller, then task 510 may identify the entire group of memory buffer devices without specifying which device within that group has actually failed. In alternate embodiments, additional information may be provided that will enable process 500 to actually pinpoint the failed device within the group. In addition, process 500 can generate visual, audio, or other indicia of the target memory buffer device (or the group of devices that contain the target memory buffer device) for display, rendering, printing, transmission, or the like (task 512). As one example, this indicia may be a displayed identification code, a physical address location, a port number, or the like. This indicia enables a service technician to locate the bad memory buffer device for repair or replacement.

Referring to FIG. 6, system address decoding process 600 may be performed during task 508 of process 500. As noted above, process 600 may be performed by the host computer system itself or by a remote computing device that receives the system address from the host computer system. In a distributed processing architecture, process 600 may be performed by multiple systems.

Process 600 may begin by obtaining the system address corresponding to the target memory buffer device (task 602). For ease of description, the obtained system address is labeled A_{S} in FIG. 6. As an initial check, process 600 may compare A_{S} to the system address limit for the host computer system (task 604). If A_{S} is greater than the system address limit, then an error or inconsistency has occurred and process 600 exits. In other words, if A_{S} is not within the range of valid system addresses, then A_{S} has no contextual meaning within the domain of the host computer system. If A_{S} is less than or equal to the system address limit, then process 600 can proceed to determine a target node in the computer system, using A_{S}. Reference number 605 indicates the tasks performed during this determination.

Process 600 searches for the target node to which the target memory buffer device is assigned. For ease of description, the illustrated embodiment of process 600 uses Node Zero as an arbitrary starting point (task 606). Of course, any of the nodes in the host computer system could be selected as the initial node for process 600. Process 600 then compares A_{S} to the node address limit of the node that is currently under analysis (Node Zero for this iteration). If A_{S} is greater than the node address limit of Node Zero (query task 608), then process 600 assumes that the target memory buffer device is not associated with Node Zero, and process 600 proceeds to a query task 610. Query task 610 checks whether Node Zero is the last node to be analyzed. If so, then an error or inconsistency has occurred and process 600 exits. If not, then the next node (Node One in this example) is selected for analysis (task 612) and process 600 is reentered at query task 608. If there are no errors or inconsistencies in the data, then the processing loop of query task 608, query task 610, and task 612 will eventually confirm that A_{S} is within the node address range of one node. In this regard, if query task 608 determines that A_{S} is less than or equal to the node address limit of the node that is currently under analysis, then process 600 can identify that target node in any suitable manner (task 614). For example, process 600 may save, provide, or display an identifier for the target node. Such an identifier may be used later to locate the target memory buffer device.

As described above, each node in the computer system might have one or more memory controllers associated therewith. Accordingly, process 600 can map, convert, transform, and/or decode A_{S} into a node address of the target node (task 616). For ease of description, the mapped node address is labeled A_{N} in FIG. 6. For this example, each node is configured with a respective range of addresses. These addresses can be used to determine if a relative address is within the range of addresses supported by a memory controller. Process 600 then determines a target memory controller in the computer system, using A_{N}. Reference number 618 indicates the tasks performed during this determination.

Process 600 searches for the target memory controller to which the target memory buffer device is assigned. For ease of description, the illustrated embodiment of process 600 uses Memory Controller Zero as an arbitrary starting point (task 620). Of course, any of the memory controllers in the host computer system could be selected as the initial memory controller for process 600. Process 600 then compares A_{N} to the memory controller address limit of the memory controller that is currently under analysis (Memory Controller Zero for this iteration). If A_{N} is greater than the memory controller address limit of Memory Controller Zero (query task 622), then process 600 assumes that the target memory buffer device is not associated with Memory Controller Zero, and process 600 proceeds to a query task 624. Query task 624 checks whether Memory Controller Zero is the last memory controller to be analyzed. If so, then an error or inconsistency has occurred and process 600 exits. If not, then the next memory controller (Memory Controller One in this example) is selected for analysis (task 626) and process 600 is reentered at query task 622. If there are no errors or inconsistencies in the data, then the processing loop of query task 622, query task 624, and task 626 will eventually confirm that A_{N} is within the memory controller address range of one memory controller. In this regard, if query task 622 determines that A_{N} is less than or equal to the memory controller address limit of the memory controller that is currently under analysis, then process 600 can identify that target memory controller in any suitable manner (task 628). For example, process 600 may save, provide, or display an identifier for the target memory controller. Such an identifier may be used later to locate the target memory buffer device.

As described above, each memory controller in the computer system might have one or more channel controllers associated therewith. Accordingly, process 600 can map, convert, transform, and/or decode A_{N} into a memory controller address of the target memory controller (task 630). For ease of description, the mapped memory controller address is labeled A_{M} in FIG. 6. For this example, each memory controller is configured with a respective range of addresses. These addresses can be used to determine if a relative address is within the range of addresses supported by a channel controller. Process 600 then determines a target channel controller in the computer system, using A_{M}. Reference number 632 indicates the tasks performed during this determination.

Process 600 searches for the target channel controller to which the target memory buffer device is assigned. For ease of description, the illustrated embodiment of process 600 uses Channel Controller Zero as an arbitrary starting point (task 634). Of course, any of the channel controllers in the host computer system could be selected as the initial channel controller for process 600. Process 600 then compares A_{M} to the channel controller address limit of the channel controller that is currently under analysis (Channel Controller Zero for this iteration). If A_{M} is greater than the channel controller address limit of Channel Controller Zero (query task 636), then process 600 assumes that the target memory buffer device is not associated with Channel Controller Zero, and process 600 proceeds to a query task 638. Query task 638 checks whether Channel Controller Zero is the last channel controller to be analyzed. If so, then an error or inconsistency has occurred and process 600 exits. If not, then the next channel controller (Channel Controller One in this example) is selected for analysis (task 640) and process 600 is reentered at query task 636. If there are no errors or inconsistencies in the data, then the processing loop of query task 636, query task 638, and task 640 will eventually confirm that A_{M} is within the channel controller address range of one channel controller. In this regard, if query task 636 determines that A_{M} is less than or equal to the channel controller address limit of the channel controller that is currently under analysis, then process 600 can identify that target channel controller in any suitable manner (task 642). For example, process 600 may save, provide, or display an identifier for the target channel controller. Such an identifier may be used later to locate the target memory buffer device.

Referring again to FIG. 5, knowledge of the target channel controller enables memory buffer device identification process 500 to identify the bad memory buffer device (or a group of memory buffer devices that includes the bad memory buffer device). Thus, if there is a one-to-one relationship between target channel controllers and memory buffer devices, then the determination of the target channel controller will inherently identify the target memory buffer device. On the other hand, if there is a one-to-many relationship between target channel controllers and memory buffer devices, then the determination of the target channel controller will inherently identify at least the group of memory buffer devices coupled to the target channel controller. Resolution of the bad memory buffer device itself from this group may require additional data and/or processing.

While at least one exemplary embodiment has been presented in the foregoing detailed description, it should be appreciated that a vast number of variations exist. It should also be appreciated that the exemplary embodiment or embodiments described herein are not intended to limit the scope, applicability, or configuration of the claimed subject matter in any way. Rather, the foregoing detailed description will provide those skilled in the art with a convenient road map for implementing the described embodiment or embodiments. It should be understood that various changes can be made in the function and arrangement of elements without departing from the scope defined by the claims, which includes known equivalents and foreseeable equivalents at the time of filing this patent application.

What is claimed is:

1. A method of identifying target memory buffer devices for a computer system having a processor core, a system controller implemented in the processor core, a plurality of memory devices controlled by the system controller, and a plurality of memory buffer devices coupled between the system controller and the memory devices, the method comprising:
obtaining a system address that conveys a physical address within the computer system;
decoding the system address to determine a target channel controller in the computer system; and
identifying at least one memory buffer device associated with the target channel controller.

2. The method of claim 1, wherein identifying at least one memory buffer device comprises identifying a memory buffer device connected to the target channel controller.

3. The method of claim 1, wherein identifying at least one memory buffer device comprises identifying a group of memory buffer devices connected to the target channel controller.

4. The method of claim 1, further comprising:
performing a memory test on the computer system; and
generating the system address when the memory test detects a bad memory buffer device, the at least one memory buffer device including the bad memory buffer device.

5. The method of claim 1, wherein:
obtaining a system address comprises receiving the system address at a computing device that is remote from the computer system; and
decoding the system address is performed by the computing device.

6. The method of claim 1, wherein obtaining a system address and decoding the system address are performed by a basic input/output system (BIOS) of the computer system.

7. The method of claim 1, wherein decoding the system address comprises:
converting the system address for use with a node address domain of a target node in the computer system; and
converting a node address for use with a memory controller address domain of a target memory controller in the computer system; and
processing a memory controller address to determine the target channel controller.

8. The method of claim 7, wherein:
relative to the computer system, the at least one memory buffer device is uniquely associated with the target channel controller;
relative to the computer system, the target channel controller is uniquely associated with the target memory controller; and
relative to the computer system, the target memory controller is uniquely associated with the target node.

9. The method of claim 7, wherein decoding the system address comprises determining, from the system address, the target node from a plurality of nodes in the computer system.

10. The method of claim 7, wherein decoding the system address comprises determining, from the node address, the target memory controller from a plurality of memory controllers in the computer system.

11. The method of claim 7, wherein decoding the system address comprises determining, from the memory controller address, the target channel controller from a plurality of channel controllers in the computer system.

12. A method of identifying a target memory buffer device for a computer system, the method comprising:
obtaining a system address that conveys a physical address within the computer system;
determining, from the system address, a target node in a processing core of the computer system;
transforming the system address into a node address;
determining, from the node address, a target memory controller in the computer system, the target memory controller being uniquely associated with the target node;
transforming the node address into a memory controller address; and
determining, from the memory controller address, a target channel controller in the computer system, the target memory buffer device being uniquely associated with the target channel controller.

13. The method of claim 12, further comprising generating indicia of the target memory buffer device.

14. The method of claim 12, further comprising:
performing a memory test on the computer system; and
generating the system address when the memory test determines that the target memory buffer device has failed.

15. The method of claim 12, wherein determining the target node comprises confirming that the system address is within a node address range of the target node.

16. The method of claim 12, wherein determining the target memory controller comprises confirming that the node address is within a memory controller address range of the target memory controller.

17. The method of claim 12, wherein determining the target channel controller comprises confirming that the memory controller address is within a channel controller address range of the target channel controller.

18. A method of identifying a target memory buffer device in a computer system, the method comprising:
providing a system architecture comprising one or more processor nodes, each of the processor nodes having one or more memory controllers associated therewith, each of the memory controllers having one or more channel controllers associated therewith, and each of the channel controllers having one or more memory buffer devices associated therewith;
performing a memory test on the system architecture;
generating a system address when the memory test determines that the target memory buffer device has failed; and
processing the system address to determine a target channel controller in the computer system, the target memory buffer device being uniquely associated with the target channel controller within a domain of the system architecture.

19. The method of claim 18, wherein processing the system address comprises:
decoding the system address to determine a node address of a target processor node in the system architecture;
decoding the node address to determine a memory controller address of a target memory controller in the system architecture; and
processing the memory controller address to determine the target channel controller.

20. The method of claim 19, wherein processing the system address comprises:
identifying the target processor node by confirming that the system address is within a node address range of the target processor node;
identifying the target memory controller by confirming that the node address is within a memory controller address range of the target memory controller; and
identifying the target channel controller by confirming that the memory controller address is within a channel controller address range of the target channel controller.
